(19) United States
(12) Patent Application Publication
(10) Pub. No.: US 2007/0164176 A1
(43) Pub. Date: Jul. 19, 2007

(54) ONBOARD UNIVERSAL SUPPORT

(76) Inventor: Chin-Hui LIAO, Dali City (TW)

Correspondence Address: PATENTTM.US, P. O. BOX 82788, PORTLAND, OR, 97282-0788, US

(21) Appl. No.: 11/622,462

(22) Filed: Jan. 11, 2007

(30) Foreign Application Priority Data
Jan. 16, 2006 (TW) 095201009

(51) Int. Cl. F16M 11/04

(52) U.S. Cl. 248/176.3

(57) ABSTRACT

An onboard universal support for a vehicle includes a base adapted to be mounted inside the vehicle, a securing mount connected to the base via a connecting rod assembly which is composed of multiple rods interconnected to each other via joints. Each of the joints is composed of a first disk and having a first extension extendable into one of the rods and a second disk selectively rotatable relative to the first disk and has a second extension extendable into another one of the rods such that inclination of the rods is changeable relative to the joints to facilitate access to an object on top of the securing mount.

### BACKGROUND OF THE INVENTION

1. Field of the Invention

The present invention relates to an onboard universal support, and more particularly to an onboard universal support which is able to firmly support a laptop computer inside a vehicle to allow the user to employ the laptop computer steadily.

2. Description of the Prior Art

A conventional onboard support (1) is shown in FIG. 1, wherein the support has a base (40), multiple supporting rods (20) interconnected together with one another via a joint (10) which is composed of a first disk (11), a second disk (12) facing the first disk (11) and a securing element (13) extending through the first disk (11) and the second disk (12) and having a wedged head (31) formed on an end of a handle (132) of the securing element (13) such that when the handle (132) is pivoted relative to a side face of the first disk (11) to allow the wedged head (131) to firmly engage with and push the side face of the first disk (11), engagement between the first disk (11) and the second disk (12) is secured. Furthermore, either the first disk (11) or the second disk (12) has a connecting collar (17) formed thereon so as to firmly receive therein one end of the supporting rod (20) such that the supporting rods (20) are staggered with respect to one another on the joints (10). On a very top connecting rod (20), a platform (30) is provided to have pairs of holes (31) defined along two opposed sides of the platform (30) and extending through the sides of the platform (30) to allow strips of adhesive belts (50) to extend therethrough. Each of the adhesive belts (50) has two ends respectively provided with a male connector (51) and a female connector (52) extending out of the side face of the platform (30).

With the base (40) securely mounted on a side face inside a vehicle (not shown), the user is able to use the adhesive belts (50) to confine movement of any object, e.g. a laptop computer, placed on top of the platform (30).

However, due to the maneuverability limitation of the connecting rods (20), each of the connecting rods (20) can only be pivoted to one direction only to meet the user's requirements, users onboard the vehicle can not satisfactorily employ the object supported by the conventional onboard support. Therefore, a secondary onboard support maybe an option for different requirements inside the vehicle. Again, due to limited space inside the vehicle, should a secondary support be mounted inside the vehicle, the available space inside the vehicle is even more limited and the riding comfort is thus sacrificed.

To overcome the shortcomings, the present invention tends to provide an improved onboard universal support to mitigate the aforementioned problems.

### SUMMARY OF THE INVENTION

The primary objective of the present invention is to provide an onboard support which is able to provide versatile maneuverability to meet the user's requirements.

In order to accomplish the aforementioned objective, the onboard universal support of the present invention includes a base, a connecting rod, joints and a securing mount. Each connecting rod is able to rotate 360 degrees relative to an adjacent connecting rod so as to provide versatile maneuverability function.

Another objective of the present invention is that each joint has an extension rod extending outward therefrom and into an adjacent connecting rod having a quick-release clamp mounted on two opposed ends of the connecting rod such that after the extension rod is extended into the adjacent connecting rod, the quick-release clamp is able to secure engagement between the extension rod and the connecting rod. Because the depth of extension of the extension rod into the connecting rod is determined by the user, height adjustment of the onboard support of the present invention is easily accomplished.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a conventional onboard support;

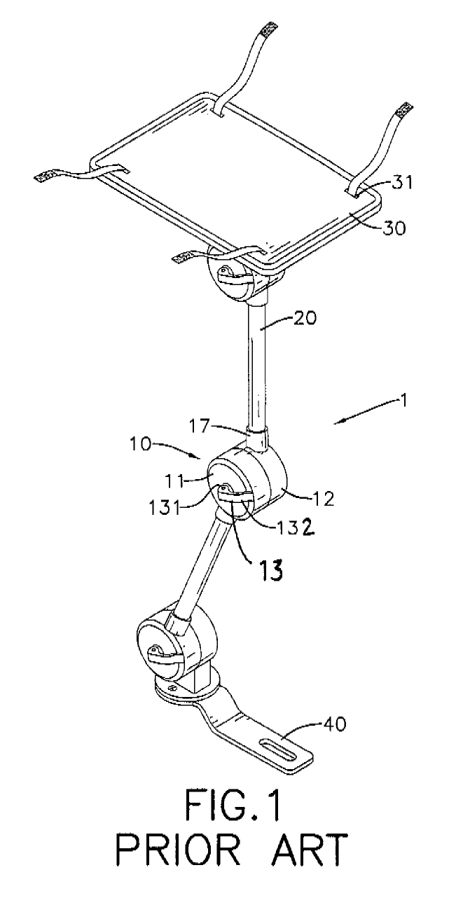

FIG. 2 is a perspective view of the onboard universal support of the present invention;

FIG. 3 is a perspective view of the onboard universal support of the present invention with the platform removed;

FIG. 4 is side plan view showing the onboard universal support of the present invention can be balanced by provision of a threaded bolt having a flared head;

FIG. 5 is a perspective view of the onboard universal support of the present invention without the platform;

FIG. 6 is a side plan view showing different embodiment of the base of the present invention;

FIG. 7 is a schematic side plan view showing the onboard universal support is mounted on the vehicle floor;

FIG. 8 is a schematic side plan view showing that a laptop computer is mounted on the securing mount;

FIG. 9 is a schematic side plan view showing that a camera is mounted directly on the securing mount; and

FIG. 10 is a schematic side plan view showing that the base is substantially L-shaped.

### DETAILED DESCRIPTION OF THE PREFERRED EMBODIMENT

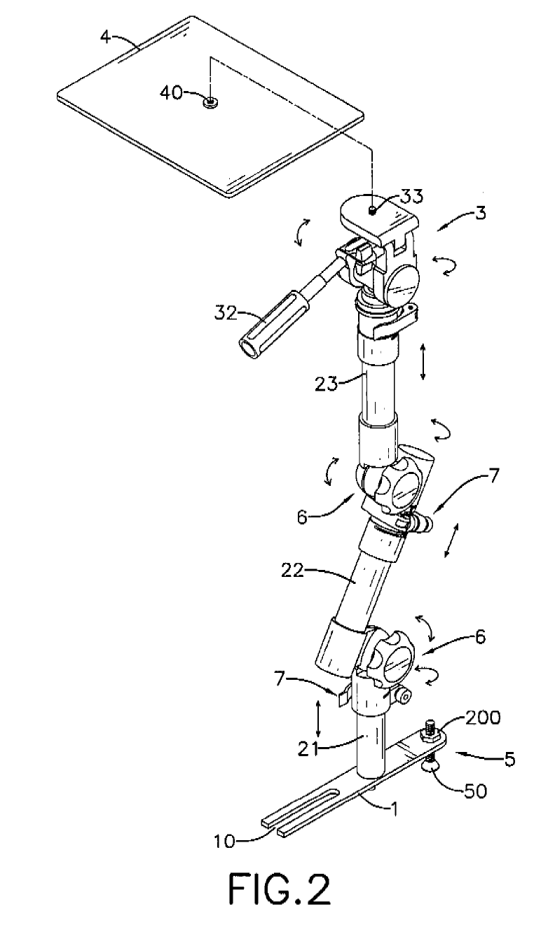

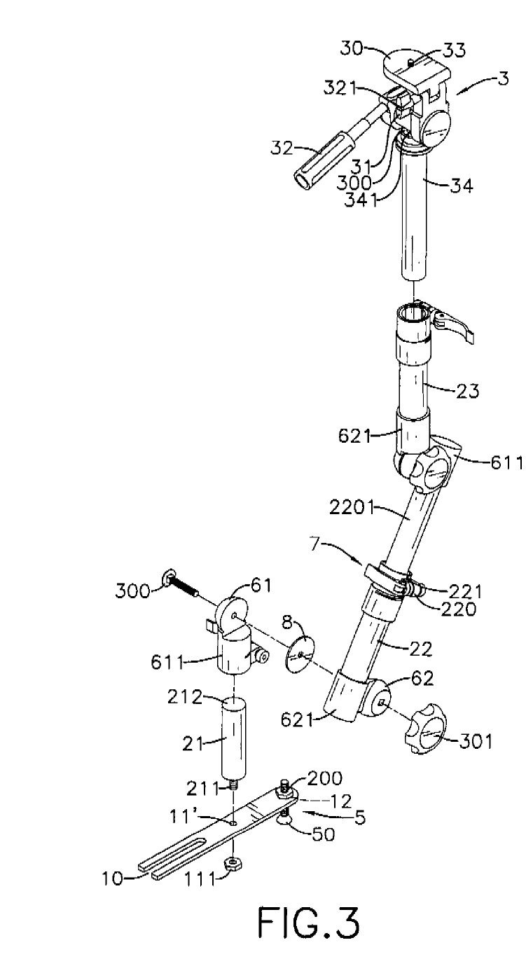

With reference to FIGS. 2 and 3, it is noted that the onboard universal support in accordance with the present invention include a base (1), a connecting rod (2), joints (6) and a securing mount (3).

The base (1) of the present invention is an elongated metal plate with a substantially U-shaped cutout (10), a first threaded hole (11′) defined in a mediate portion of the metal plate and a second threaded hole (12) defined in a position opposite to that of the U-shaped cutout (10). A threaded bolt (5) with a flared head (50) is able to extend through the second threaded hole (12) to mate with a nut (200).

The connecting rod (2) is composed of a bottom rod (21), a mediate rod (22) and a top rod (23). The bottom rod (21) has a threaded extension (211) integrally formed on a bottom face of the bottom rod (21) to extend into the first threaded hole (11′) so that the bottom rod (21) is able to be firmly mounted on top of the base (1) and a top end (212).

Each joint (6) has a first disk (61) and a second disk (62). The first disk (61) has a hollow first extension (611) extending outward therefrom and having a bottom open end defined in a bottom face of the first extension (611) to receive therein an adjacent rod, i.e. the top end (212) of the bottom rod (21) in this embodiment. The second disk (62) has a second extension (621) extending outward therefrom to correspond to a bottom open end of an adjacent rod. A rubber disk (8) is sandwiched between the first disk (61) and the second disk (62). Furthers each of the first disk (61), the second disk (62) as well as the rubber disk (8) is provided with a through hole (not numbered) such that a securing bolt (300) is able to extend through all the through holes of the first disk (61), the second disk (62) and the rubber disk (8) to mate with a securing nut (301) to keep the rubber disk (8) firmly sandwiched between the first disk (61) and the second disk (62) to function as a stop so as to avoid relative movement of the first disk (61) to the second disk (62) or vice versa.

The mediate rod (22) has two open ends respectively defined in the top end and bottom end of the mediate rod (22) to receive therein the second extension (621) from the second disk (62) of the joint (6). The top open end of the mediate rod (22) has a slit (221) axially defined through an outer periphery of the mediate rod (22) and two ledges (220) formed on a periphery defining the top open end of the mediate rod (22) so that a quick-release clamp (7) mounted around the top open end of the mediate rod (22) is able to reduce the dimension of the top open end of the mediate rod (22) when the quick-release clamp (7) is in operation. In addition, an auxiliary extension (2201) is extendable from the top open end of the mediate rod (22). Therefore, the user is able to use the quick-release clamp (7) to control length of the auxiliary extension (2201) extending out of the mediate rod (22).

The structure of the top rod (23) is the same as that of the mediate rod (22). That is, the top rod (23) has a open end and a quick-release clamp (7) is mounted around the top open end of the top rod (23) to reduce the dimension of the top open end when the quick-release clamp (7) is operated.

The securing mount (3) has a supporting face (30), a locking handle (31), a controlling handle (32), a locking bolt (33) and an extension (34). The supporting face (30) is substantially U-shaped and has a receiving hole (300) defined in a lower portion of the supporting face (30).

The locking handle (31) is mounted on a side face of the securing mount (3) to control relative movement of the supporting face (30) to the extension (34) and the controlling handle (32) is mounted on a side face of the securing mount (3) to control inclination of the supporting face (30) relative to the extension (34). The locking bolt (33) is mounted on and extended out of the supporting face (30) for combination with an object such as a camera, etc. The extension (34) is integrally extending from a bottom face of the lower portion of the supporting face (30) and has a head (341) formed on a top end thereof to be snugly received in the receiving hole (300) of the supporting face (30). The locking handle (31) is extending into the lower portion of the supporting face (30) to selectively allow the upper portion of the supporting face (30) to pivot relative to the lower portion of the supporting face (30) such that by extending the locking handle (31) further into the lower portion of the supporting face (30), an entirety of the supporting face (30) is able to be fixed relative to the head (341). However, when the locking handle (31) is loosened, i.e. to extend away from the head (341), the user is able to control the pivotal movement of the upper portion of the supporting face (30) relative to the lower portion of the supporting face (30). Besides a gap (321) is defined in the lower portion of the supporting face (30) and the controlling handle (32) is threadingly extended into the lower portion of the supporting face (30) and through the gap (321). Therefore, the user is able to use the controlling handle (32) to control the inclination of the supporting face (30) relative to the head (341). An auxiliary supporting plate (4) is also provided to the supporting face (30), wherein the auxiliary supporting plate (4) has a combining hole (40) defined through the auxiliary supporting plate (4) to correspond to and mate with the locking bolt (33) extending out of the supporting face (30). With the provision of the auxiliary supporting plate (4), the user is able to hold an object such as a laptop computer on top of the auxiliary supporting plate (4).

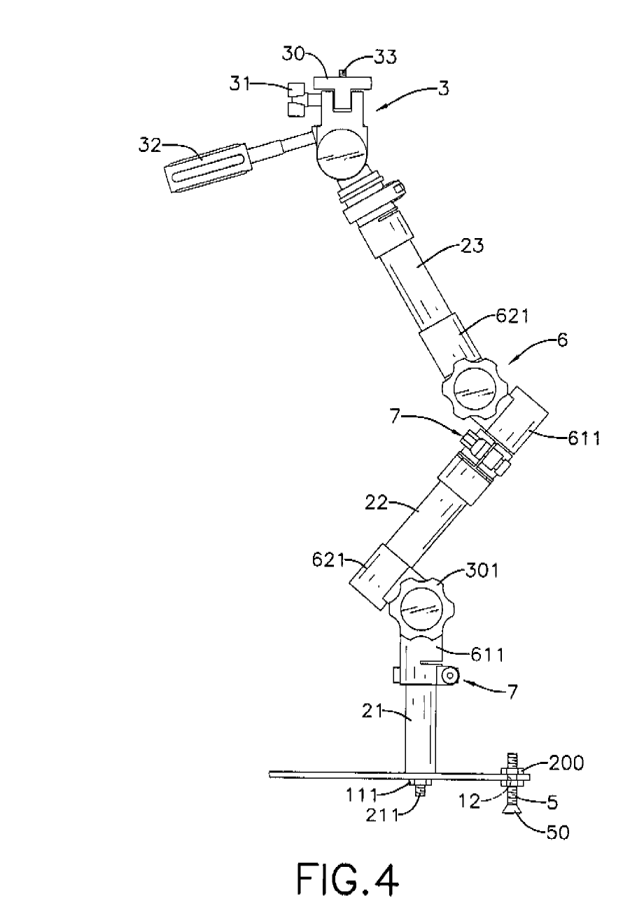

With reference to FIG. 4 and still using FIG. 3 for reference, it is noted that when the onboard universal support is assembled, the threaded extension (211) of the lower rod (21) is extended into the first threaded hole (11′) of the base (1) and a nut (111) is provided to secure the threaded extension (211) on the base (1). Then the threaded bolt (5) is extended into the second threaded hole (12) to mate with the nut (200) so that the user is able to adjust the extension of the threaded bolt (5) relative to the base (1). Then the top end (212) of the lower rod (21) is extended into the first extension (611) of the first disk (61) and the quick-release clamp (7) is employed to secure the top end (212) of the lower rod (21) inside the first extension (611). After the securing bolt (300) is extended through the through holes of the first disk (61), the rubber disk (8) and the second disk (62) to mate with the securing nut (301), the user is able to secure that there is no relative movement between the first disk (61) and the second disk (62). Thereafter, the bottom end of the mediate rod (22) is extending into the second extension (621) of the second disk (62) to combine the joint (6) with the mediate rod (22). The top end of the auxiliary extension rod (2201) of the mediate rod (22) is extended into another first extension (611) of another joint (6) for combination with the mediate rod (22). Two quick-release clamps (7) respectively on the top end and the bottom end of the mediate rod (22) are operated to reduce dimensions of the top open end and the bottom open end respectively of the mediate rod (22) to secure the bottom end in the second extensions (621) of the joint (6) and the top end of the auxiliary extension rod (2201) in the first extension (611) of the joint (6). After the first second extension (621) on top of the mediate rod (22) is securely engaged with the bottom end of the top rod (23) and the extension (34) of the supporting face (30) is extended into the top open end of the top rod (23), the entire combination of the present invention is finished.

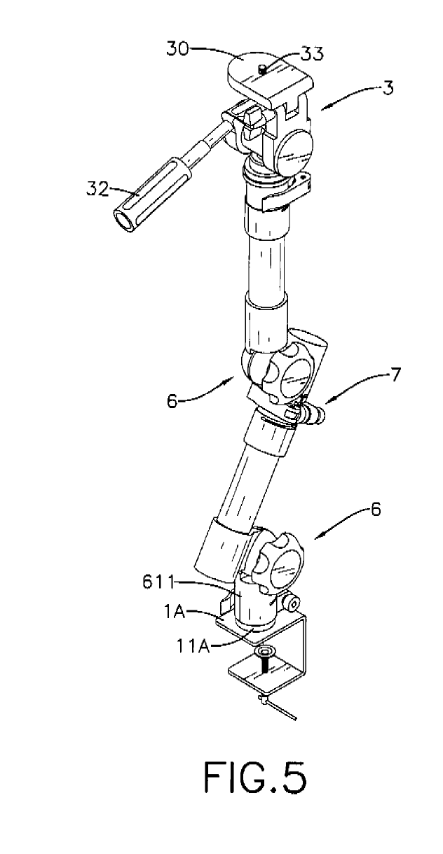

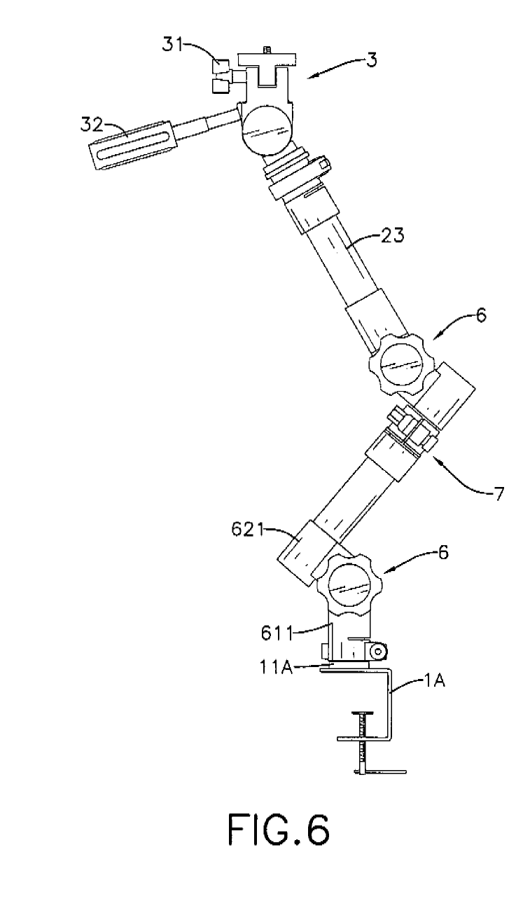

From the depiction of FIGS. 5 and 6, it is noted that the base (1A) has now a U-shaped configuration and an auxiliary tube (11A) is formed on a side face of the base (1A) for receiving therein the first extension of the joint (6). Due to the configuration change of the base (1A), the universal support of the present invention may also be adapted to be mounted on a desk.

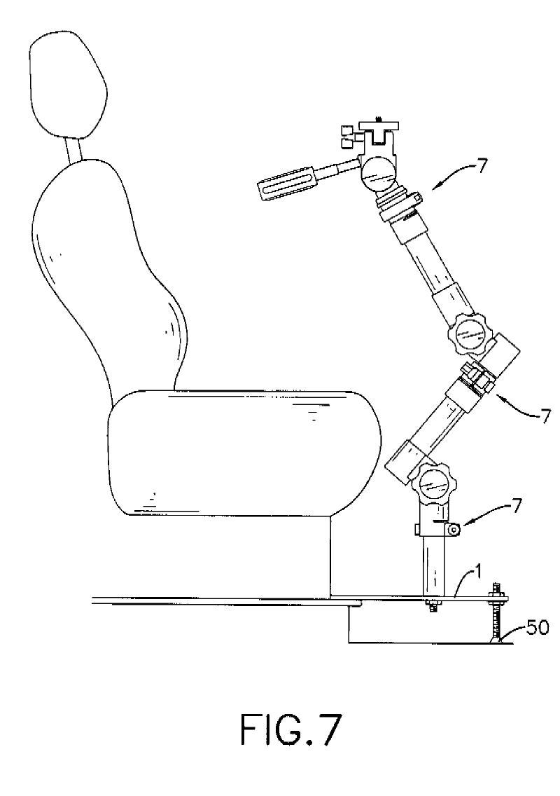

With reference to FIG. 7, it is noted that when the onboard universal support of the present invention is mounted on a floor inside a vehicle, the user is able to use the flared head (50) to balance the base (1) so as to level the base (1) with the vehicle floor. Furthermore, the user may choose to loosen any designated quick-release clamp (7) to rotate the joint (6) relative to the connecting rod (2) or to extend the connecting rod (2) relative to the first extension (611) or the second extension (621). Besides, the user may also loosen the securing bolt (300) to rotate the first disk (61) relative to the second disk (61) or vice versa to change relative position of the first disk (61) to the second disk (62). Due to the easy maneuverability of the connecting rod (2) as well as the joint (6), the user is able to rotate or pivot the supporting face (30) to any angle required without modification to any existing structure.

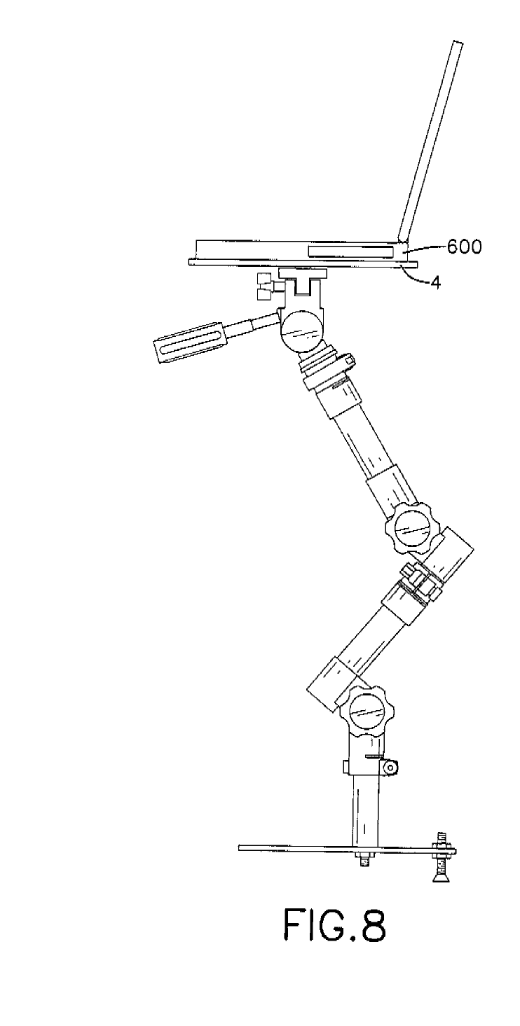

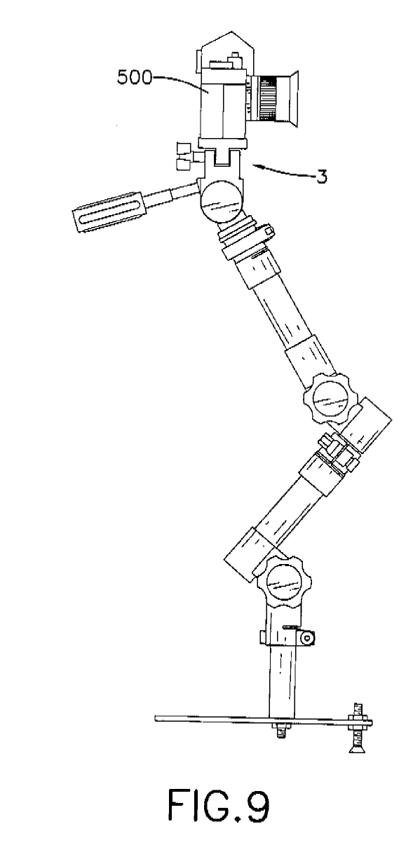

With reference to FIGS. 8 and 9, it is noted that with the provision of the auxiliary supporting plate (4), a laptop computer (600) is securely supported. However, when the auxiliary supporting plate (4) is removed, a camera (500) is easily mounted on the supporting face of the securing mount (3) via the locking bolt (33) (not shown in this drawing but shown in FIG. 3).

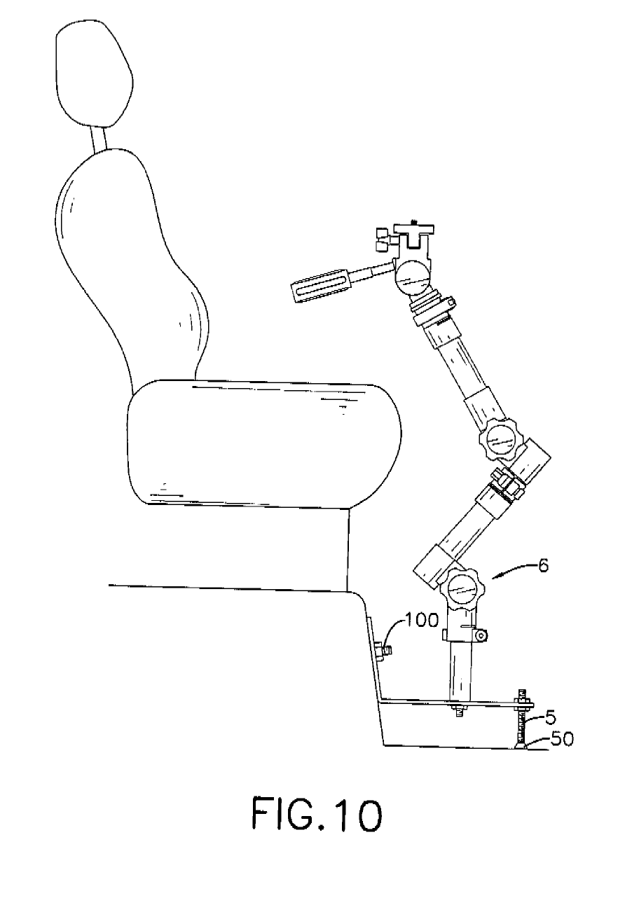

With reference to FIG. 10, it is noted that the base may be L-shaped to adapt to different positions inside the vehicle and a combination of an auxiliary bolt and nut (100) may be applied to secure one side of the L-shaped base and the threaded bolt (5) is used to secure the other side of the L-shaped base.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An onboard universal support for a vehicle, the onboard universal support comprising:
a base adapted to be mounted inside the vehicle;
a securing mount connected to the base via a connecting rod assembly which is composed of multiple rods interconnected to each other via joints, wherein each of the joints is composed of a first disk having a first extension engageable with one of the rods and a second disk selectively rotatable relative to the first disk and having a second extension engageable with another one of the rods such that inclination of the rods is changeable relative to the joints to facilitate access to an object on top of the securing mount.

2. The support as claimed in claim 1, wherein the connecting rod assembly is composed of a bottom rod, a mediate rod and a top rod, the bottom rod has a threaded extension extending from a bottom face of the bottom rod and into the base to allow the bottom rod to be firmly mounted on top of the base and a top end defined in a top end of the bottom rod to extend into the first extension of the first disk of the joint.

3. The support as claimed in claim 2, wherein the first extension of the joint has a quick-release clamp mounted around an outer periphery of the first extension so that after the first extension of the first disk of the joint receives the top end of the bottom end, operation of the quick-release clamp is able to reduce dimension of the first extension of the joint to secure the bottom rod inside the first extension.

4. The support as claimed in claim 2, wherein the mediate rod has two ends respectively defined in a bottom end and a top end of the mediate rod and a slit axially defined in the top end of the mediate rod and a quick-release clamp is mounted around the top end of the mediate rod to reduce dimension of the top end of the mediate rod so that after the second extension of one of the joints receives the bottom end and the first extension of the other one of the joints receives the top end of the mediate rod, operation of the quick-release clamp is able to secure the mediate rod inside the first extension and the second extension.

5. The support as claimed in claim 3, wherein the mediate rod has two ends respectively defined in a bottom end and a top end of the mediate rod and a slit axially defined in the top end of the mediate rod and a quick-release clamp is mounted around the top end of the mediate rod to reduce dimension of the top end of the mediate rod so that after the second extension of one of the joints receives the bottom end and the first extension of the other one of the joints receives the top end of the mediate rod, operation of the quick-release clamp is able to secure the mediate rod inside the first extension and the second extension.

6. The support as claimed in claim 2, wherein the top rod has a top end and a slit axially and respectively defined in the top end of the top rod and a quick-release clamp is mounted around the top end of the top rod to reduce dimension of the top end of the top rod so that after the second extension of one of the joints receives a bottom end and an extension extending from a bottom face of the securing mount is extended into the top end of the top rod, operation of the quick-release clamp is able to reduce dimension of the top end of the top rod to secure the extension of the securing mount inside the top rod.

7. The support as claimed in claim 3, wherein the top rod has a top end and a slit axially and respectively defined in the top end of the top rod and a quick-release clamp is mounted around the top end of the top rod to reduce dimension of the top end of the top rod so that after the second extension of one of the joints receives a bottom end and an extension extending from a bottom face of the securing mount is extended into the top end of the top rod, operation of the quick-release clamp is able to reduce dimension of the top end of the top rod to secure the extension of the securing mount inside the top rod.

8. The support as claimed in claim 4, wherein the top rod has a top end and a slit axially and respectively defined in the top end of the top rod and a quick-release clamp is mounted around the top end of the top rod to reduce dimension of the top end of the top rod so that after the second extension of one of the joints receives a bottom end and an extension extending from a bottom face of the securing mount is extended into the top end of the top rod, operation of the quick-release clamp is able to reduce dimension of the top end of the top rod to secure the extension of the securing mount inside the top rod.

9. The support as claimed in claim 5, wherein the top rod has a top end and a slit axially and respectively defined in the top end of the top rod and a quick-release clamp is mounted around the top end of the top rod to reduce dimension of the top end of the top rod so that after the second extension of one of the joints receives a bottom end and an extension extending from a bottom face of the securing mount is extended into the top end of the top rod, operation of the quick-release clamp is able to reduce dimension of the top end of the top rod to secure the extension of the securing mount inside the top rod.

10. The support as claimed in claim 1, wherein the securing mount has a supporting face with a locking bolt extending out of a top portion of the supporting face for combination with an object, a receiving hole defined through a bottom portion of the supporting face, a locking handle extending into the bottom portion of the supporting face, a controlling handle firmly mounted on a side face of the supporting face and an extension extending from a bottom face of the supporting face and having a head formed on a top end of the extension to be received inside the receiving hole such that a forward extension of the locking handle into the supporting face enables the locking handle to control pivotal movement of a top portion relative to a lower portion of the supporting face and a rearward extension of the locking handle away from the supporting face enables the locking handle to move away further from the head so as to allow the top portion to pivot relative to the bottom portion.

11. The support as claimed in claim 2, wherein the securing mount has a supporting face with a locking bolt extending out of a top portion of the supporting face for combination with an object, a receiving hole defined through a bottom portion of the supporting face, a locking handle extending into the bottom portion of the supporting face, a controlling handle firmly mounted on a side face of the supporting face and an extension extending from a bottom face of the supporting face and having a head formed on a top end of the extension to be received inside the receiving hole such that a forward extension of the locking handle into the supporting face enables the locking handle to control pivotal movement of a top portion relative to a lower portion of the supporting face and a rearward extension of the locking handle away from the supporting face enables the locking handle to move away further from the head so as to allow the top portion to pivot relative to the bottom portion.

12. The support as claimed in claim 5, wherein the securing mount has a supporting face with a locking bolt extending out of a top portion of the supporting face for combination with an object, a receiving hole defined through a bottom portion of the supporting face, a locking handle extending into the bottom portion of the supporting face, a controlling handle firmly mounted on a side face of the supporting face and an extension extending from a bottom face of the supporting face and having a head formed on a top end of the extension to be received inside the receiving hole such that a forward extension of the locking handle into the supporting face enables the locking handle to control pivotal movement of a top portion relative to a lower portion of the supporting face and a rearward extension of the locking handle away from the supporting face enables the locking handle to move away further from the head so as to allow the top portion to pivot relative to the bottom portion.

13. The support as claimed in claim 6, wherein the securing mount has a supporting face with a locking bolt extending out of a top portion of the supporting face for combination with an object, a receiving hole defined through a bottom portion of the supporting face, a locking handle extending into the bottom portion of the supporting face, a controlling handle firmly mounted on a side face of the supporting face and an extension extending from a bottom face of the supporting face and having a head formed on a top end of the extension to be received inside the receiving hole such that a forward extension of the locking handle into the supporting face enables the locking handle to control pivotal movement of a top portion relative to a lower portion of the supporting face and a rearward extension of the locking handle away from the supporting face enables the locking handle to move away further from the head so as to allow the top portion to pivot relative to the bottom portion.

14. The support as claimed in claim 7, wherein the securing mount has a supporting face with a locking bolt extending out of a top portion of the supporting face for combination with an object, a receiving hole defined through a bottom portion of the supporting face, a locking handle extending into the bottom portion of the supporting face, a controlling handle firmly mounted on a side face of the supporting face and an extension extending from a bottom face of the supporting face and having a head formed on a top end of the extension to be received inside the receiving hole such that a forward extension of the locking handle into the supporting face enables the locking handle to control pivotal movement of a top portion relative to a lower portion of the supporting face and a rearward extension of the locking handle away from the supporting face enables the locking handle to move away further from the head so as to allow the top portion to pivot relative to the bottom portion.

15. The support as claimed in claim 8, wherein the securing mount has a supporting face with a locking bolt extending out of a top portion of the supporting face for combination with an object, a receiving hole defined through a bottom portion of the supporting face, a locking handle extending into the bottom portion of the supporting face, a controlling handle firmly mounted on a side face of the supporting face and an extension extending from a bottom face of the supporting face and having a head formed on a top end of the extension to be received inside the receiving hole such that a forward extension of the locking handle into the supporting face enables the locking handle to control pivotal movement of a top portion relative to a lower portion of the supporting face and a rearward extension of the locking handle away from the supporting face enables the locking handle to move away further from the head so as to allow the top portion to pivot relative to the bottom portion.

16. The support as claimed in claim 9, wherein the securing mount has a supporting face with a locking bolt extending out of a top portion of the supporting face for combination with an object, a receiving hole defined through a bottom portion of the supporting face, a locking handle extending into the bottom portion of the supporting face, a controlling handle firmly mounted on a side face of the supporting face and an extension extending from a bottom face of the supporting face and having a head formed on a top end of the extension to be received inside the receiving hole such that a forward extension of the locking handle into the supporting face enables the locking handle to control pivotal movement of a top portion relative to a lower portion of the supporting face and a rearward extension of the locking handle away from the supporting face enables the locking handle to move away further from the head so as to allow the top portion to pivot relative to the bottom portion.

17. The support as claimed in claim 13, wherein the base has a flared head extendable from a bottom face of the base for leveling the base with a floor of the vehicle, a rubber disk is sandwiched between the first disk and he second disk to function as a stop to avoid rotation of the first disk relative to the second disk.

18. The support as claimed in claim 14, wherein the base has a flared head extendable from a bottom face of the base for leveling the base with a floor of the vehicle, a rubber disk is sandwiched between the first disk and he second disk to function as a stop to avoid rotation of the first disk relative to the second disk.

19. The support as claimed in claim 15, wherein the base has a flared head extendable from a bottom face of the base for leveling the base with a floor of the vehicle, a rubber disk is sandwiched between the first disk and he second disk to function as a stop to avoid rotation of the first disk relative to the second disk.

20. The support as claimed in claim 16, wherein the base has a flared head extendable from a bottom face of the base for leveling the base with a floor of the vehicle, a rubber disk is sandwiched between the first disk and he second disk to function as a stop to avoid rotation of the first disk relative to the second disk and the securing mount has an auxiliary supporting plate detachably mounted thereon for support of the object.
